(19) United States
(12) Patent Application Publication
(10) Pub. No.: US 2025/0381430 A1
(43) Pub. Date: Dec. 18, 2025

(54) MOBILE LIQUID DEPLOYMENT VEHICLE AND SYSTEM

(71) Applicant: WALL OF WATER INC., Kanata (CA)

(72) Inventor: David Brian McKeen, Kanata (CA)

(21) Appl. No.: 18/707,345

(22) PCT Filed: Nov. 4, 2021
(86) PCT No.: PCT/CA2021/051569

§ 371 Date: May 3, 2024

(51) Int. Cl. A62C 27/00; A62C 3/02; A62C 31/28; B05B 9/00; B05B 15/72

(52) U.S. Cl. CPC A62C 27/00; A62C 3/0292; A62C 31/28; B05B 9/007; B05B 15/72

(57) ABSTRACT

Provided is a mobile liquid deployment vehicle and system. The vehicle comprises a mobile liquid deployment vehicle, comprising a carriage having a plurality of ground engaging wheels; a tower containing a channel therein that is hingedly connected to the carriage, a first end of the tower having an input connector to receive liquid; and an output device attached to a second end of the tower that is configured to receive liquid from the tower for deployment. The tower is able to move between a stowed position and a spraying position. A system is also disclosed, in which a plurality of vehicles are fluidly connected, such as in series, to deploy liquid over a vast area. Once set up, a vehicle and the system can be operated in an autonomous or semi-autonomous manner to aid in fighting and/or preventing fires.

### FIELD OF THE INVENTION

The invention generally relates to the field of mobile liquid deployment vehicles. In particular, the invention relates to a vehicle that disperses liquid to suppress fires, or to soak buildings or terrain as a preventative measure in advance of a fire. The invention also relates to a system comprising a number of vehicles that may be connected in series.

### BACKGROUND OF THE INVENTION

Although wildfires are a natural phenomenon, their frequency and severity appears to be growing. Wildfires typically occur in dry forested areas, and the combustible nature of the surrounding vegetation encourages quick and often uncontrollable spreading. Embers or sparks can travel via wind to other flammable areas, which propagates the wildfire. If the embers or sparks find their way to residential areas, this can cause the loss of homes, subdivisions, and even towns. The unpredictable nature of a wildfire often leads to loss of life including frontline firefighters and the general population residing in the area.

The use of autonomous or semi-autonomous firefighting equipment is becoming more common. Such equipment includes motorized or robotic vehicles that deploy water as needed. Rapidly deploying such vehicles to battle active fires, or to soak homes in advance of the fire as a preventative measure, is a safer option and provides added support.

### SUMMARY OF THE INVENTION

According to an aspect of the present invention, there is provided a mobile liquid deployment vehicle. The vehicle comprises a carriage having ground engaging wheels. The carriage supports a conduit having an input connector that can receive an inflow of a liquid. Branching upward from the conduit is a neck portion containing a channel therein, that is hingedly attached to a tower.

The tower defines a channel therein, and can be raised into an erect spraying position, in which a first end of the tower forms a substantially water tight seal with the neck portion. The tower can be hingedly lowered into a stowed position. An output device is rotatably attached to a second end of the tower, and is in liquid communication with the tower channel.

According to another aspect of the present invention, there is provided a system for deploying liquid. The system comprises a plurality of vehicles as described herein in fluid communication with each other. Preferably the plurality of vehicles are connected in series. The system may also include a means of supplying a liquid to a first vehicle in the series, such as a water pumping truck or a tanker truck.

In one embodiment, the vehicle comprises at least one horizontal support connected to an upper portion of a frame of the carriage, the at least one horizontal support extending substantially transversely to the length of the carriage, and anchoring the conduit to the carriage.

In an embodiment, the vehicle comprises means to raise the tower between an erect spraying position and a prone stowed position.

In an embodiment, the neck portion and/or the tower comprises a swivel connection that allows the tower to rotate about the neck portion between an erect spraying position and a prone stowed position.

In an embodiment, the vehicle comprises an intermediate portion positioned between and fluidly connecting the neck portion and the tower, the intermediate portion comprising a swivel connection that allows the tower to rotate about the neck between an erect spraying position and a prone stowed position.

In an embodiment, the intermediate portion is U-shaped, and the connection between the neck and tower is configured such that the tower is substantially parallel to the conduit when in the stowed position.

In an embodiment, the vehicle comprises a tower support attached to the carriage that receives the tower when it is in a stowed position.

In an embodiment, the output device is rotatably attached to the second end of the tower.

In an embodiment, the output device is a sprayer, a water cannon, a mister, or a fogger.

In an embodiment, the vehicle comprises an auxiliary connection in fluid communication with the conduit.

In an embodiment, a second end of the conduit comprises an output connector.

In an embodiment, the vehicle comprises at least one post rotatably connected to the carriage, the at least one post having a ground engaging member at one end, and a mechanism to telescopically alter the length of the at least one post.

In an embodiment, the vehicle comprises means to raise and lower the output device to alter a launch angle of the liquid.

### BRIEF DESCRIPTION OF THE DRAWINGS

The present invention will now be described in further detail in which:

FIG. 1 is a perspective view of a vehicle according to an embodiment of the invention in a stowed or transport position;

FIG. 2 is photograph of a vehicle according to an embodiment of the invention with the bracing members in a ground-engaging position;

FIG. 3 is another perspective view of the vehicle as shown in FIG. 1;

FIG. 4 is another perspective view of the vehicle as shown in FIG. 1;

FIG. 5 is another perspective view of the vehicle as shown in FIG. 1 with the tower in a spraying position;

FIG. 6 is a photograph of a perspective view of an output device mounted to a vehicle according to an embodiment of the invention;

FIG. 7 is a fragmentary perspective view of a vehicle according to an embodiment of the invention in a stowed or transport position;

FIG. 8 is a front perspective view of a vehicle according to another embodiment in a stowed position;

FIG. 9 is a rear perspective view of the vehicle as shown in FIG. 8;

FIG. 10 is a front perspective view of the vehicle as shown in FIG. 8 with the tower in a spraying position;

FIG. 11 is a rear perspective view of the vehicle as shown in FIG. 10;

FIG. 12 is a front perspective view of a vehicle according to a third embodiment with the tower in a stowed position;

FIG. 13 is a rear perspective of the vehicle shown in FIG. 12;

FIG. 14 is a front perspective view of the vehicle shown in FIG. 12 with the tower in a spraying position;

FIG. 15 is a rear perspective view of the vehicle shown in FIG. 14;

FIGS. 16A and 16B are photographs of an embodiment of a coupling at the base of the tower;

FIG. 17 is a rear perspective view of a vehicle according to a fourth embodiment with the tower in a spraying position;

FIG. 18 is a front perspective of the vehicle shown in FIG. 17;

FIG. 19 is a rear perspective view of the vehicle shown in FIG. 17 with the tower in a stowed position;

FIG. 20 is a front perspective view of the vehicle shown in FIG. 19;

FIG. 21A is a fragmentary view of a vehicle with the tower in a stowed position; and FIG. 21B is a fragmentary view of a vehicle with the tower in a spraying position;

FIGS. 22A and 22B are fragmentary views showing embodiments of latching mechanisms to secure the tower in a spraying position;

FIGS. 23A and 23B are fragmentary views showing embodiments of latching mechanisms to secure the tower in a stowed position;

FIG. 24 is a rear perspective view of the vehicle shown in FIG. 17 with a mobile pump;

FIG. 25 is a perspective view of a system according to an embodiment of the invention;

FIG. 26 is another perspective view of a system according to an embodiment of the invention; and

FIG. 27 is a perspective view of yet another embodiment of the invention.

### DETAILED DESCRIPTION OF THE INVENTION

A better understanding of the present invention and its objects and advantages will become apparent to those skilled in this art from the following detailed description, wherein there is described preferred embodiments of the invention. As will be realized, the invention is capable of modifications in various obvious respects, all without departing from the scope and spirit of the invention. Accordingly, the description should be regarded as illustrative in nature and not as restrictive to such embodiments, and features of each embodiment described herein may be combined with each other to form further embodiments.

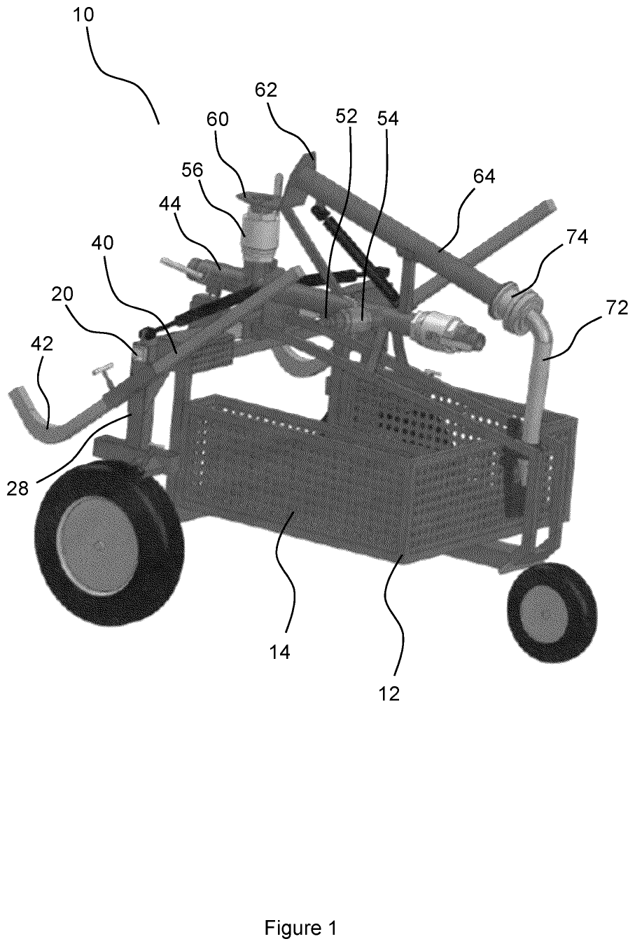

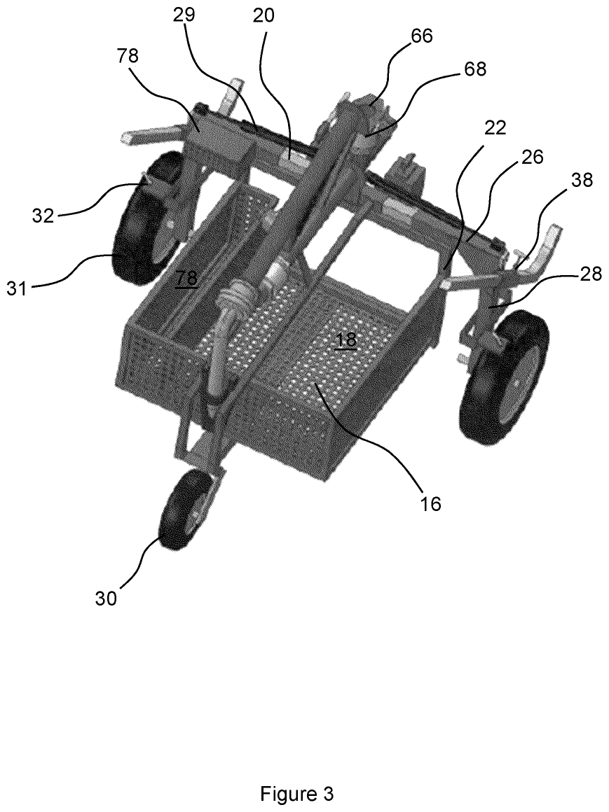

A vehicle 10 according to a first embodiment of the present invention is shown in FIGS. 1-7. The vehicle 10 includes a carriage 12 having side walls 14 and a floor 16. The rear wall of the carriage 12 may be absent, or may be hingedly connected in the form of a gate, to improve access to the interior of the carriage 12. The interior of the carriage 12 is intended to transport equipment that may be necessary for the operation of the vehicle 10, such as fire hoses. The interior 18 of the carriage may have hose reels (not shown) mounted therein to accommodate the fire hoses. At least one ground engaging front wheel 30 may be coupled to the front of the carriage 12. In one embodiment, a single front wheel 30 is rotatably attached to the carriage 12. Preferably, the front wheel 30 is able to swivel to increase the maneuverability of the vehicle 10. Optionally, a front portion of the carriage includes a hitch 15. The hitch 15 can be used to tow vehicles 10 into their desired position.

In one embodiment, a horizontal support 20 having a length greater than the width of the carriage 12 extends substantially transversely across the rear of the carriage 12. Posts 22 extending upward from the rear corners of the carriage 12 support the horizontal support 20 above the carriage 12. In another embodiment, the horizontal support 20 attaches to the top of the side walls 14 of the carriage 12.

Attached to each end of the horizontal supports is a leg 24. Each leg is generally L-shaped, having a first portion 26 of the leg that is slidably attached to the horizontal support 20, and a second portion 28 of the leg 24 that extends downward. The first portion 26 of the leg 24 may slidably extend outward along the horizontal support 20. When both legs 24 are in an extended position, a broader base is formed which may provide additional stability to the vehicle 10, particularly when it is in operation. The legs 24 may then slide inward along the horizontal support 20, forming a more compact vehicle 10 which is preferred for transport. The vehicle 10 may have means 29 to assist with the sliding movement of the legs 24, such as hydraulics. Rear ground engaging wheels 31 are coupled to the second portion 28 of the legs 24. In an alternate arrangement, the rear wheels could be attached directly to the carriage 12.

A braking mechanism 32 that impedes the rotation of the rear wheels 30 may be coupled to the second portion 28 of the legs 24. For example, the braking mechanism 32 may have a threaded portion and a friction portion, and be engaged with a threaded aperture attached to the second portion 28 of the leg 24. As the braking mechanism 32 is rotated and threaded through the aperture, the friction portion contacts the wheel 31, thereby inhibiting or hindering the rotation thereof.

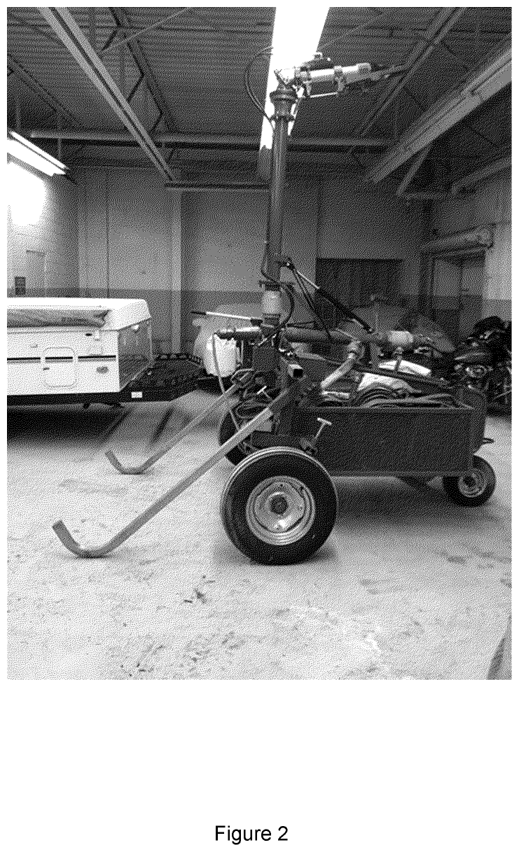

Attached to a second portion 28 of each leg is a guide 34. The guide 34 slidingly engages a bracing member 36. The bracing member 36 has a body portion 40 that travels through the guide 36, and a foot portion 42 that may engage the ground. The bracing member 36 may slide through the guide 34 between a first position (see e.g. FIG. 1) in which the bracing member 36 is in an elevated position and the foot portion 42 does not engage the ground, and a second position (see e.g. FIG. 2) in which the bracing member 36 is in a lowered position and the foot portion 42 contacts the ground. The guide 34 is angled and positioned such that when the bracing member 36 is deployed in the second position, the bracing member 36 does not interfere with the rear wheels 31. The first position is preferred during transport of the vehicle 10, while the bracing members 36 are preferably deployed into the second position when the vehicle 10 is in operation.

Mounted substantially transversely on top of the support 20 along the length of the carriage 12 is a longitudinal conduit 44. The conduit 44 has an input connector 46 at a first end for connecting the vehicle 10 to a liquid source, such as a fire hydrant, water pumping vehicle, and the like. The vehicle 10 may also be equipped with a pumping device (not shown) to facilitate the introduction of liquid into the conduit 44 from passive sources, such as pools, lakes, rivers, etc. The flow of liquid through the input connector 46 is regulated by an input valve. The opposing second end of the conduit 44 has an output connector 48. The output connector 48 can connect the vehicle 10 to a subsequent vehicle 10, such as with a hose. The flow of liquid through the output connector 48 is regulated by an output valve 50. Along the length of the conduit 44, there may be at least one auxiliary connector 52 regulated by an auxiliary valve 54. The auxiliary connector 52 allows a user to attach equipment, such as a fire hose, directly to the conduit, which may be desirable if the operator needs to direct liquid at immediate targets. It is understood that the valves 50, 54 can be any type of valve, including e.g. a ball valve, a gate valve, a plug valve, a butterfly valve, a check valve, and the like. The connectors 46, 48, 52 can be configured as any type of connector that enables connections with typical fire hoses. Preferably, the conduit 44 has an interior diameter of 4 inches to 5 inches.

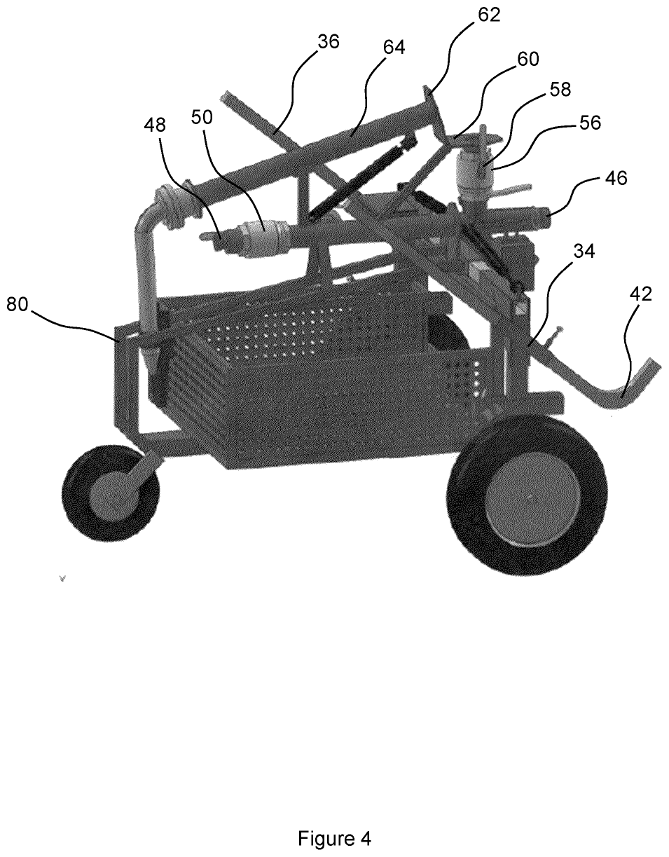

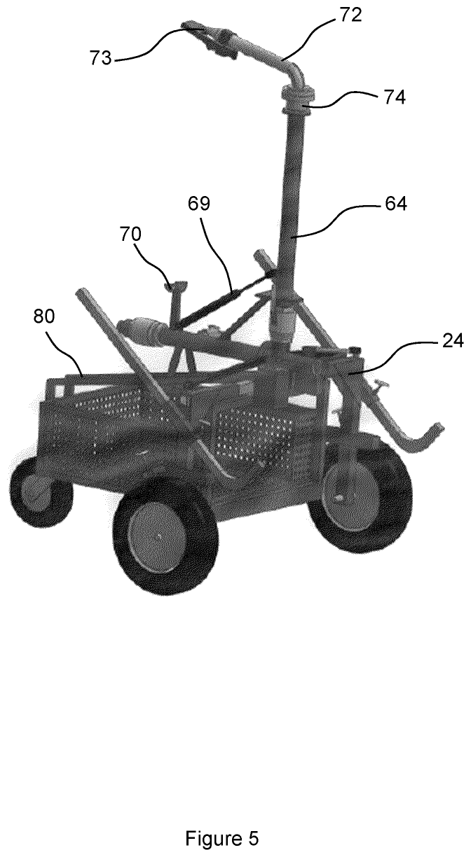

As can be seen in FIGS. 4 and 5, extending substantially vertically from the conduit is a neck portion 56. The neck portion 56 defines a channel therein, and is in fluid communication with the conduit 44. The flow of liquid through the neck portion 56 is regulated by a tower valve 58. The tower valve 58 can be any type of valve, including e.g. a ball valve, a gate valve, a plug valve, a butterfly valve, a check valve, and the like. Preferably, the neck portion 56 has a flange 60 surrounding an upper opening. The neck flange 60 is hingedly attached to a flange 62 surrounding a first end of a tower 64. The tower 64 defines a channel therethrough, and through its connection with the neck 56, may be hingedly raised into an erect spraying position, that is preferably substantially vertical. Preferably, there is a locking mechanism (not shown), such as e.g. a securing pin, to secure the tower in the spraying position.

When in the spraying position, the neck flange 60 and the tower flange 62 abut or mate, and the tower 64 and the neck 56 form a substantially water tight connection. The strength of the connection may be facilitated by the presence of a gasket 66 at the interface between the neck 56 and the tower 64.

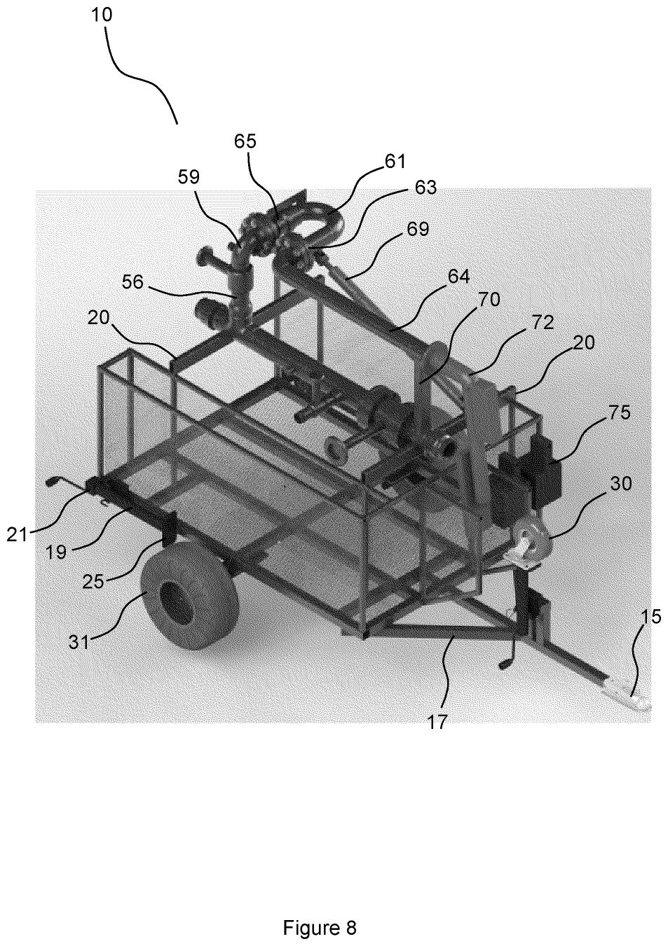

FIGS. 8-11 illustrate a second embodiment of the vehicle 10, showing modified versions of the carriage 12 and tower 64. In this embodiment, similar features are denoted with the same reference characters.

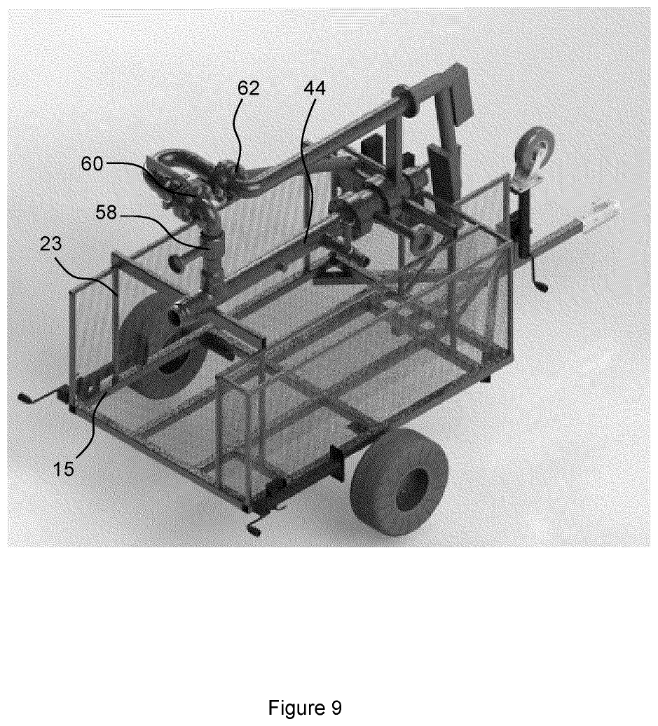

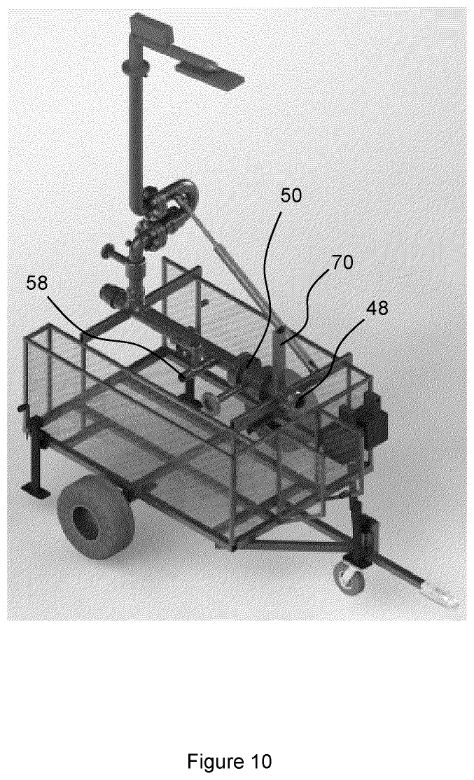

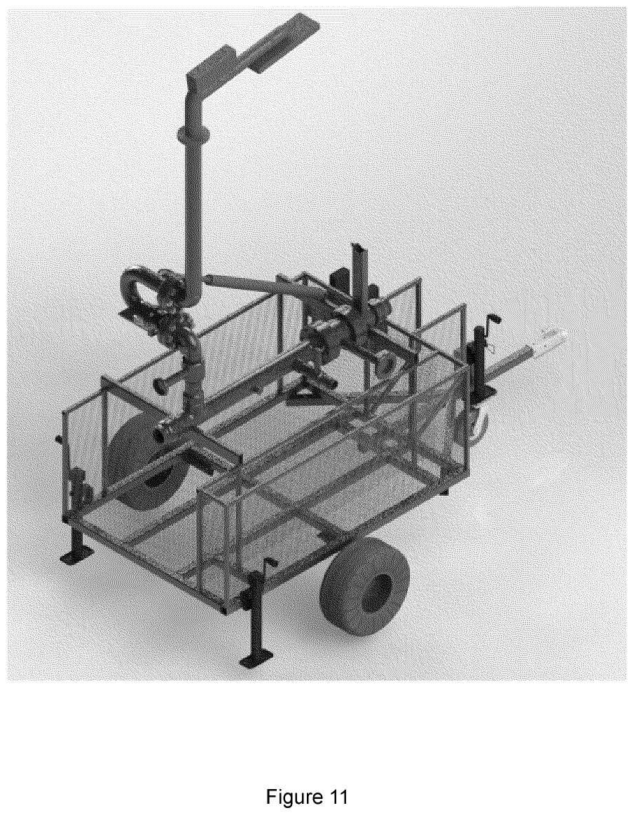

Similar to the previous embodiment, the vehicle 10 includes a carriage 12 having side walls 14 and a floor 16. Underneath the floor is a frame 15 that provides structural support to the carriage 12. The rear wall of the carriage 12 may be absent, or may be hingedly connected in the form of a gate, to improve access to the interior of the carriage 12. In this embodiment, there is a hitch 15 attached to the carriage 12 via structural elements 17 to facilitate towing of the vehicle 10. A post 19, having a ground engaging front wheel 30 at one end, is rotatably attached to at least one of the structural elements 17. The post 19 can be rotated to place the front wheel 30 in an elevated position during transport of the vehicle 10 (see FIGS. 8 and 9). Alternatively, when the vehicle 10 is in its intended position, the post 19 is rotated to place the front wheel 30 in a ground engaging position to stabilize the vehicle 10 (see FIGS. 10 and 11). The post 19 may be telescopic to allow incremental adjustments of the height of the post 19, which can contribute to levelling the vehicle 10. The telescopic ability of the post 19 can be controlled through a mechanism, such as a crank 21. Alternatively, instead of a front wheel 30, the post may have a flat base (not shown), that engages with the ground to provide support.

Rear wheels 31 are rotatably mounted near the rear of the carriage 12. The wheels may be equipped with a suspension system, such as shock absorbers, to minimize turbulence when the vehicle 10 is in motion.

In this embodiment, a plurality of horizontal supports 20 extends substantially transversely across the carriage 12. Support posts 23 extending upward from the frame 15 support the horizontal supports 20.

In this embodiment, additional posts 19 are rotatably attached to the rear of the carriage 12. These posts 19 have a ground engaging base 25 at one end. Each post 19 can be rotated to place the base 25 in an elevated position during transport of the vehicle 10 (see FIGS. 8 and 9). Alternatively, when the vehicle 10 is in its intended location, each post 19 is rotated to place the base 25 in a ground engaging position to stabilize the vehicle 10 (see FIGS. 10 and 11). The post 19 may be telescopic to allow incremental adjustments of the height of the post 19, which can contribute to levelling the vehicle 10. The telescopic ability of the post 19 can be controlled through a mechanism, such as a crank 21.

As with the previous embodiment, mounted substantially transversely on top of the supports 20 along the length of the carriage 12 is a longitudinal conduit 44. The features of the conduit 44 are as disclosed above.

As can be seen in FIGS. 8-11, extending from the conduit, such as in a substantially vertical direction, is a neck portion 56. The neck portion 56 defines a channel therein, and is in fluid communication with the conduit 44. The flow of liquid through the neck portion 56 is regulated by a tower valve 58. The tower valve 58 can be any type of valve, including e.g. a ball valve, a gate valve, a plug valve, a butterfly valve, a check valve, and the like. In this embodiment, above the tower valve 58 is a bend 59. The bend 59 is preferably about 90 degrees, and is substantially perpendicular to the length of the conduit 44. After the bend 59 is a neck flange 60 that serves as a connection point with the tower 64.

In the embodiment illustrated in FIGS. 8-11, the neck flange 60 is connected to a U-shaped intermediate portion 61. The intermediate portion 61 has flanges 63 on each end. A flange 63 on a first end of the intermediate portion 61 sealingly connects with the neck flange 60, and a flange 63 on the opposing second end of the intermediate portion sealingly connects with a flange 62 at a first end of a tower 64. The tower 64 defines a channel therethrough, and a first end of the tower has a bend 67 adjacent the tower flange 62. The neck bend 59 and the tower bend 67 allow for the connection of the neck portion 56 and the tower 64 while maintaining a configuration that is substantially parallel to the conduit 44, and that does not require sealing and unsealing the interior channel of the vehicle 10.

The intermediate portion 61 has a swivel coupling 65 contained therein. The swivel coupling 65 can be located near a first end of the intermediate portion 61, or near the second end of the intermediate portion 61. The swivel coupling 65 allows the intermediate portion 61 to rotate, which will move the tower 64 from a stowed position (see FIGS. 8 and 9), to a deployed spraying position (see FIGS. 10 and 11). In a further variation, the swivel coupling 65 can be located on the neck portion 56 adjacent the neck flange 60 and/or on the tower 64 adjacent the tower flange 62.

Alternatively, the intermediate portion 61 can be omitted, and the neck flange 60 may connect directly with the flange 62 at a first end of the tower 64 (not shown). In this variation, the tower 64 and/or the neck portion 56 has a swivel coupling 65 adjacent the tower flange 62 or neck flange 60, respectively, such that the tower 64 is able to rotate up into a deployed spraying position.

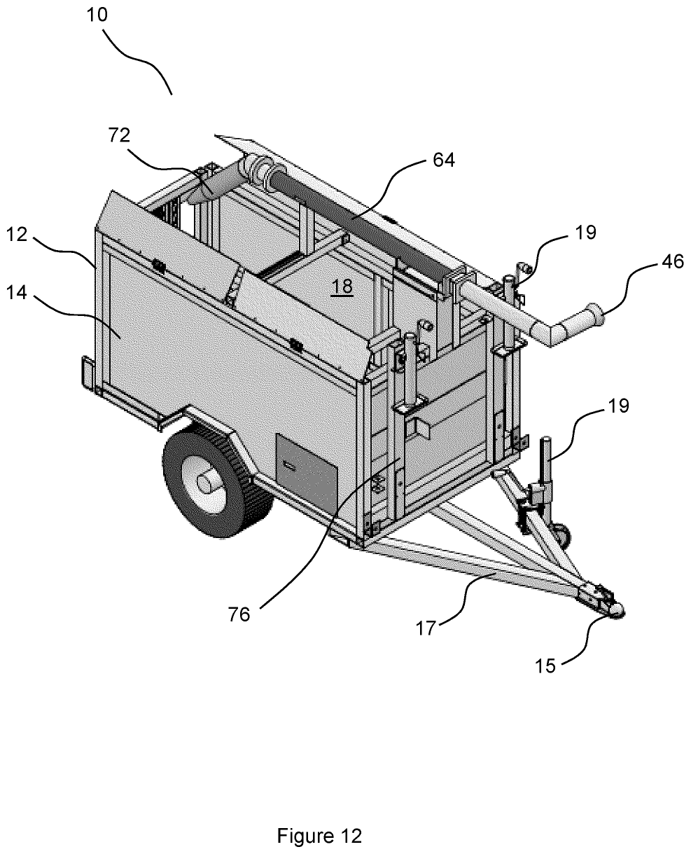

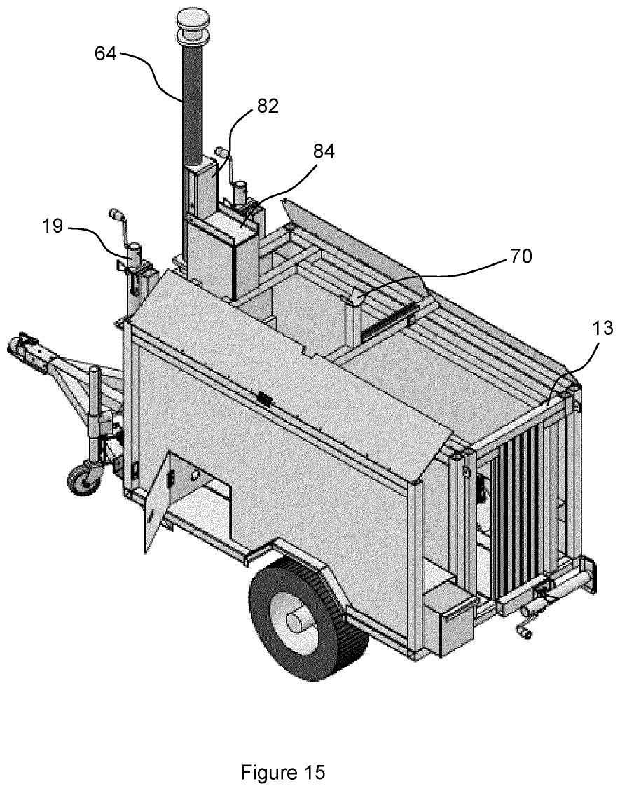

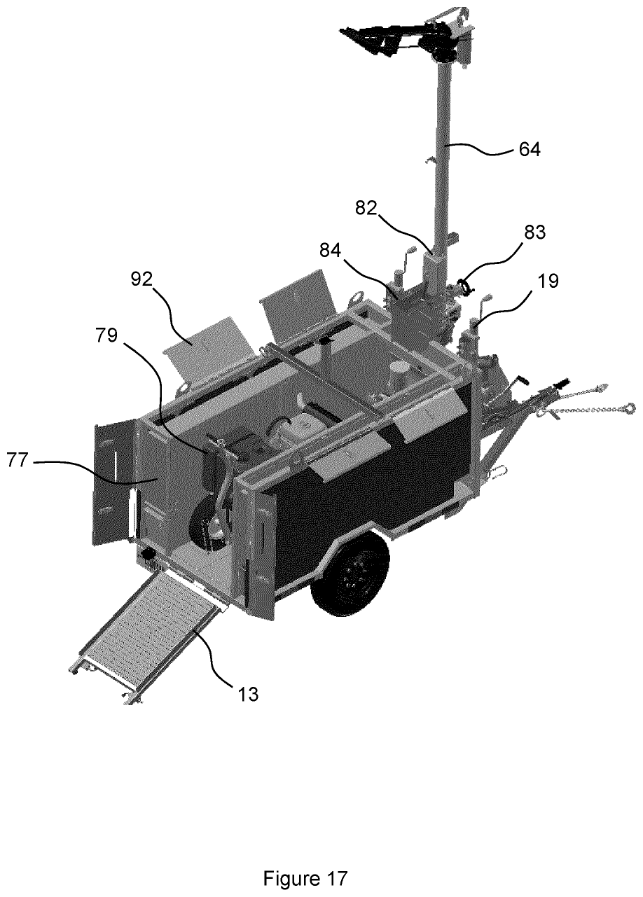

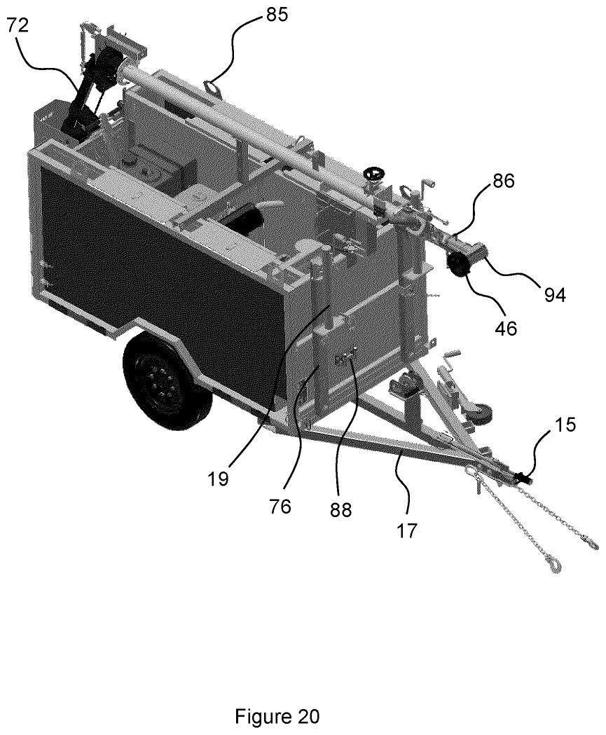

FIGS. 12-16 illustrate a third embodiment of the vehicle 10, and FIGS. 17-23 illustrate a fourth embodiment of the vehicle 10. In these embodiments, similar features are denoted with the same reference characters.

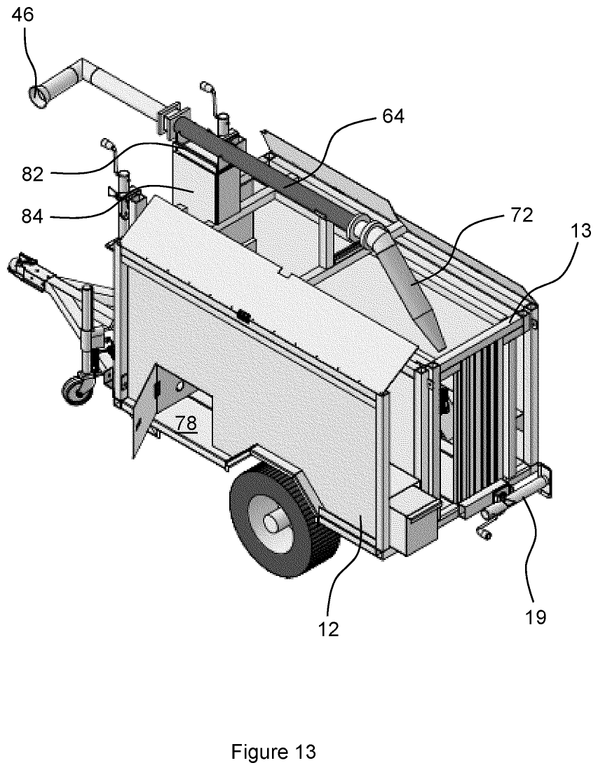

Similar to the previous embodiments, the vehicle 10 in these embodiments includes a carriage 12 having side walls 14 and a floor 16. The interior 18 of the carriage 12 may be partitioned into one or more compartments 78 that can be utilized to store and transport any necessary equipment, such as hoses, tools, etc. For example, some of the compartments 78 can be accessible from the side of the carriage (see FIG. 13), some are accessible from the top of the carriage 12, and the carriage 12 may have a main compartment 77 that is sized and dimensioned to receive a water pump 79 (See e.g. FIGS. 17-20 and 24). Some or all of the compartments 78 may be shielded with a cover 92 to secure the contents contained therein.

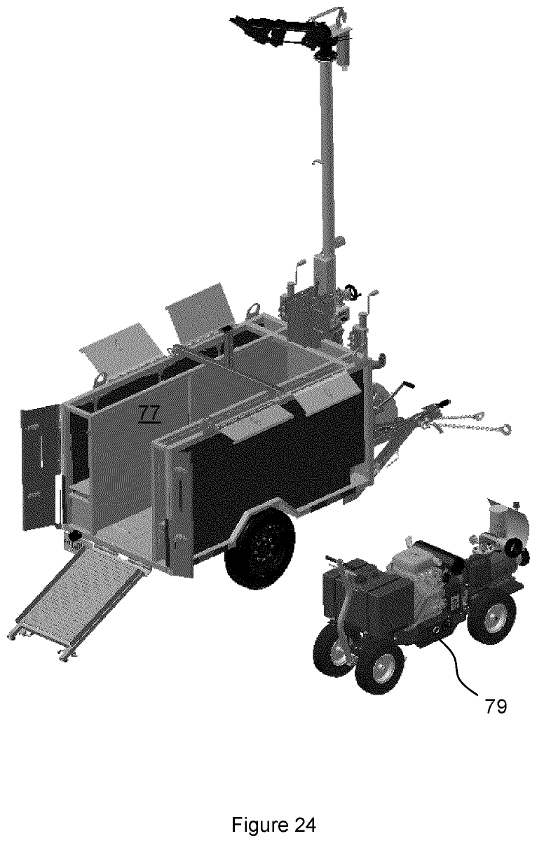

The rear of the carriage 12 may have a door 13 that can serve as a ramp, or alternatively, the rear of the carriage can have one or more swing doors that can also serve to enclose compartments 77, along with a door 13 that serves as a ramp (See e.g. FIGS. 17 and 24). The door 13 is rotatably attached to the carriage 12 and rotates about its base and extends outward to engage the ground. Small vehicles, such as an ATV or a mobile pump 79, can be loaded into the main compartment 77 of the carriage 12.

In the third and fourth embodiments, there is a hitch 15 attached to the carriage 12 via structural elements 17 to facilitate towing of the vehicle 10. A post 19, such as a jack, having a ground engaging front wheel 30 at one end, is rotatably attached to at least one of the structural elements 17. The post 19 can be rotated to place the front wheel 30 in an elevated position during transport of the vehicle 10. Alternatively, when the vehicle 10 is in its intended position, the post 19 is rotated to place the front wheel 30 in a ground engaging position to stabilize and assist in maneuvering the vehicle 10. The post 19 may be telescopic to allow incremental adjustments of the height thereof, which can contribute to levelling the vehicle 10. The telescopic ability of the post 19 can be controlled through a mechanism, such as a crank.

Alternatively, instead of a front wheel 30, the post may have a flat base (not shown), that engages with the ground to provide support.

The vehicle according to these embodiments may include further stabilizing posts 19 as described above. For example, further posts 19 can be arranged at various points about the vehicle 10, such as the post shown at the rear of the vehicle 10 (see FIG. 13). These posts 19 may be rotatable between substantially horizontal and vertical positions as needed.

Additional stabilizing posts 19 can be seen in FIGS. 12, 14, 18, and 20, which are attached, preferably rotatably attached, to support elements 76. While these posts 19 are shown at the front of the carriage 12, they may be located at any point about the vehicle 10. The stabilizing posts 19 are able to slide up and down the respective support elements 76. When the vehicle 10 is arranged for transit, the stabilizing posts 19 are raised up the support elements 76 to not interfere with the movement of the vehicle 10. When the vehicle 10 is in its intended position, the stabilizing posts 19 are lowered down the support elements 76 so that the flat base 25 or wheel (not shown) at the bottom of the stabilizing posts 19 engages the ground to provide additional stability to the vehicle 10. Movement of the stabilizing posts 19 up and down the support elements 76 can be actuated via a crank mechanism, or alternatively, other mechanisms may be employed. For example, the stabilizing posts 19 may reside within a track in the support elements, and are held in place with a latch. After the latch has been released, the stabilizing posts are free to be manually moved along the track.

A lower portion of the support elements 76 can be rotatably attached to the carriage 12, allowing the support elements 76 to rotate about this point. For transit, the support elements 76 are arranged substantially vertically, and are secured in place with a latch or a fastener. When the vehicle 10 is in the intended position, the support elements 76 rotate about the lower portion attachment point and extend laterally outward from the vehicle 10. Optionally, the support elements 76 are telescopic, allowing for further lateral extension. In this embodiment, the stabilizing posts 19 are also rotatably attached to the support elements 76, and can rotate so that the flat base or wheel can engage the ground. By extending the stabilizing posts out laterally, additional stabilization is provided.

In the illustrated third and fourth embodiments, the tower 64 is formed of a substantially unitary piece that has a channel defined therein. At one end of the tower 64 is an input connector 46 for connecting the tower 64 to a liquid source, such as a fire hydrant, water pumping vehicle, river, pool, and the like. This connector 46 will preferably have a standard fitting that can provide a connection with a typical fire hose. Although not shown, a valve may be incorporated into the connector 46 to regulate flow of water after the tower 64 has been connected to the water source.

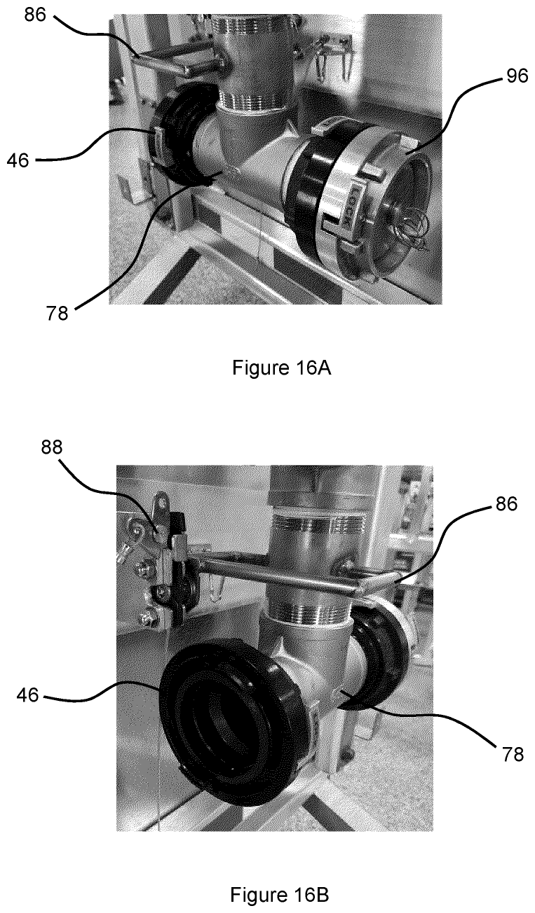

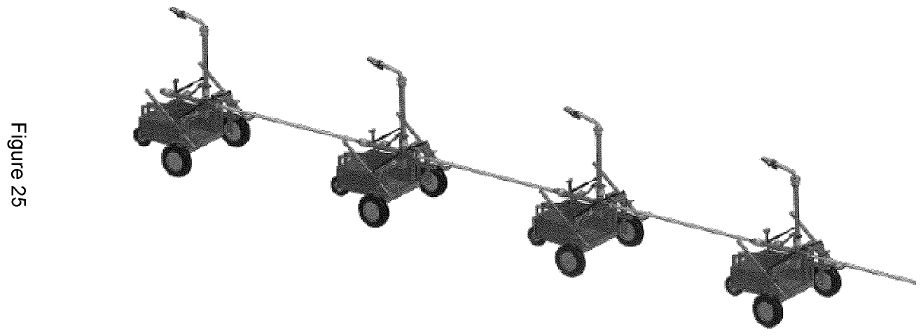

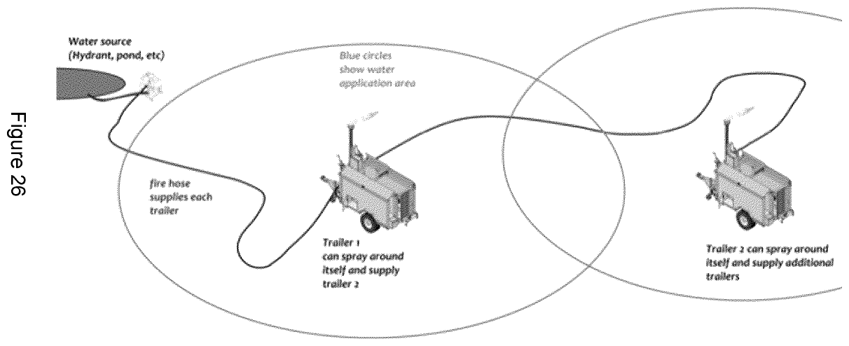

An alternative embodiment is shown in FIGS. 16A and 16B, in which the first end of the tower 64 has a T-fitting 94, which comprises two opposing connectors 46. Either connector 46 can serve as the input connector 46, while the opposing connector 46 can serve as an output connector 48. Again, it is preferred that these connectors 46, 48 have a standard fitting that can provide a connection with a typical fire hose. The output connector 48 allows for the vehicle 10 to be arranged in series with other vehicles 10, as illustrated in FIGS. 25 and 26. In this embodiment, one or both of the connectors 46, 48 may have a valve incorporated therein that can be used to regulate the flow of water within the T-fitting 94. When the input valve is open and the output valve is closed, all of the water will be directed entirely up the tower 64 to be dispersed. If the output valve is then opened as well, water will also be directed through the output connector 48, through an additional hose, and on to another vehicle 10. Connectors 46, 48 may also be fitted with a cap 96 to further block the flow of water as seen in FIG. 16A.

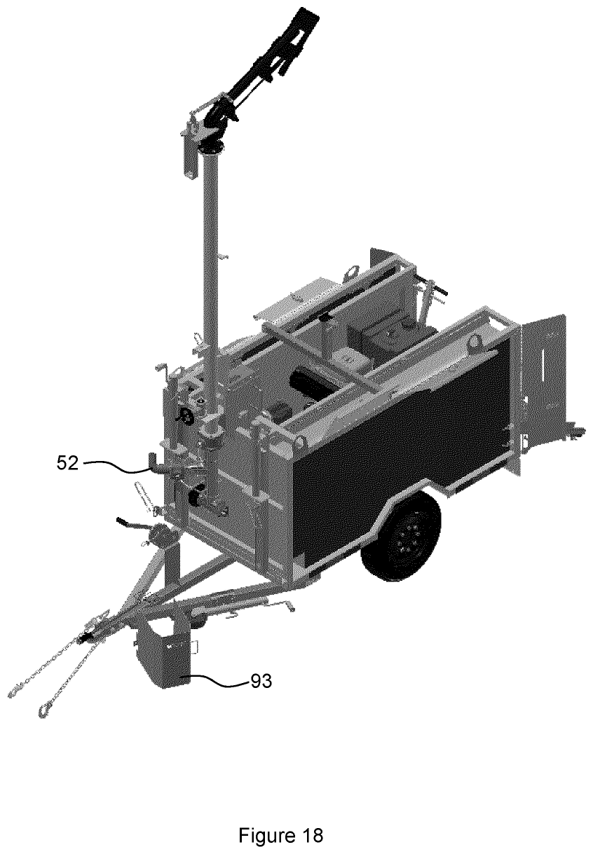

Along the length of the tower 64, preferably close to the input connector 46, there may be at least one auxiliary connector 52 (See e.g. FIGS. 18-20) that allows for auxiliary equipment to be connected to the water source. This will allow the user to attach e.g. a fire hose directly to the tower 64, which may be desirable if the user needs to direct water at targets in the immediate vicinity. Preferably, this auxiliary connector 52 have a standard fitting that can provide a connection with a typical fire hose, and will also be under the control of a valve, so that the supply to the auxiliary equipment can be turned on and off as needed while not substantially affecting the water supply to the tower 64.

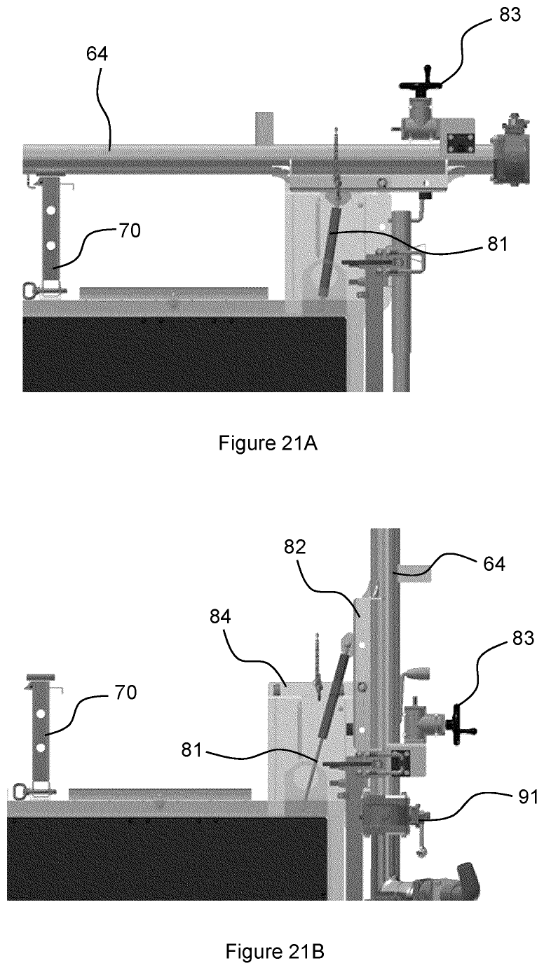

In an alternative embodiment, a single valve 91 may be placed along the length of the tower 64 to control the flow of liquid through the tower 64 (See FIG. 21B).

Attached to the second end of the tower 64 is an output device 72, which will be discussed in further detail below.

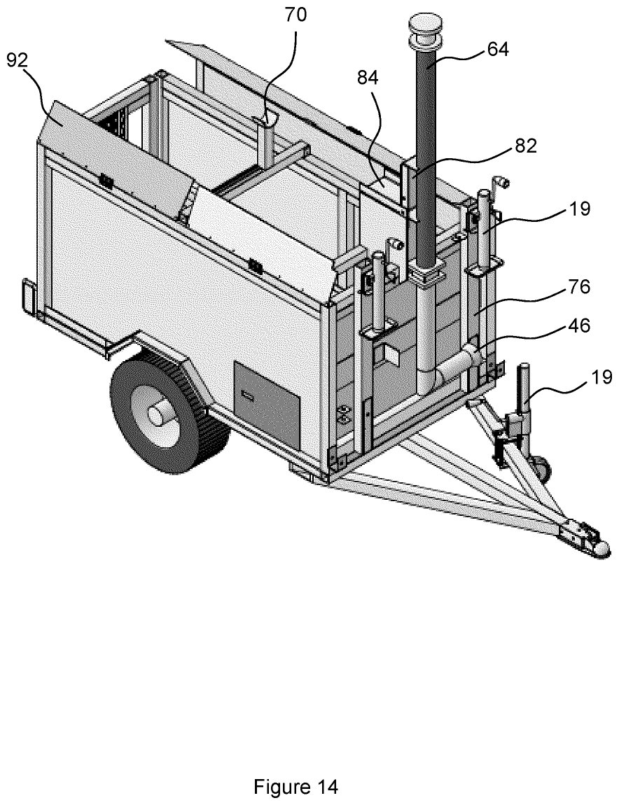

In the third and fourth embodiments, the tower 64 is preferably hingedly attached to the vehicle 10. This allows the tower 64 to be quickly conveyed from a stowed position (see FIGS. 12, 13, 19, and 10) to a spraying position (see FIGS. 14, 15, 17, and 18). The nature of the connection between the tower 64 and the carriage 12 may vary, however, in the illustrated embodiments shown in the Figures, the tower 64 is attached to a bracket 82, and the bracket 82 is hingedly attached to a platform 84 situated on the top of an end of the carriage 12. When the tower 64 is in the stowed position, it is substantially horizontal across the top of the carriage 12. The bracket 82 rests on top of, or nests within, the platform 84, which aids in supporting the tower 64. As will be discussed below, one or more tower supports 70 may extend up from the carriage 12 along the length of the vehicle 10 to provide further support to the tower 64 when it is in the stowed position.

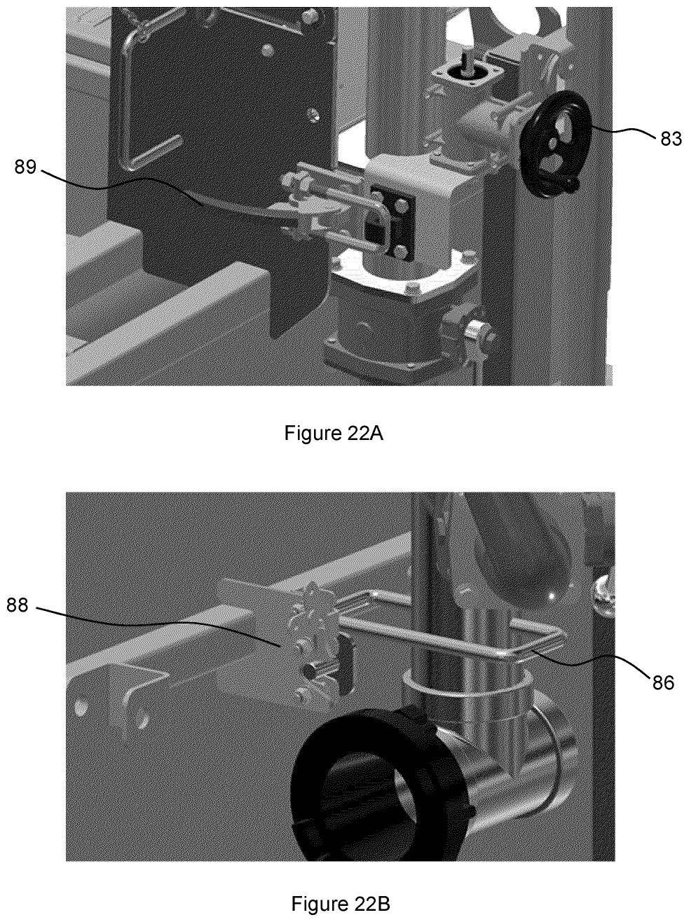

When the tower 64 is in the spraying position, it is substantially vertical. To secure the tower 64 in the spraying position, the vehicle includes at least one fastening or latching mechanism. For example, as shown in FIGS. 16A, 16B, and 22B, the tower 64 includes a catch 86 that can be used in e.g. a two point rotary latch to secure the lower portion of the tower 64 to the carriage 12. As the tower 64 is raised, the catch 86 mates with a corresponding latching portion 88 located on the carriage 12, thereby securing the tower 64 in the upright spraying position. It is possible that the latching mechanism may require further steps by the user, such as locking the latching mechanism, to further secure the position of the tower 64. The catch 86 can also serve as a handle for the operator to use when manipulating the tower 64 position, or alternatively, a separate handle to aid in manipulating the tower 64 may be provided.

Further latching mechanisms can be utilized further up the tower 64, such as an over center latch 89 close to the hinge point of the tower 64 as shown in FIG. 22A.

Although the tower 64 is illustrated as being attached to the front of the vehicle 10, it is to be understood that the tower 64 can be attached to the rear of the vehicle 10, or even on one of the sides. Furthermore, it is contemplated that a vehicle 10 may be outfitted with more than one tower 64, which would increase the amount of water that can be dispersed by a single vehicle 10, thereby increasing the area that can be simultaneously covered.

The following features are generally applicable to some or all embodiments of the vehicle 10 as described above.

When the tower 64 is in the spraying position, liquid provided to the conduit 44, if present, can now be redirected up the tower 64 for deployment. Preferably, when erected into the spraying position, the height of the tower 64 is 2 to 10 meters.

When not in use, the tower 64 can be hingedly lowered down into a stowed position. Raising means 69, such as hydraulics or struts, such as air struts, can be incorporated to facilitate the raising and lowering of the tower 64. The carriage 12 can be outfitted with enclosures 75 that contain the equipment necessary to operate the raising means. In the first embodiment, the hinges are positioned and arranged such that the lowered tower 64 extends forward over the carriage 12, preferably substantially parallel to the conduit 44. Similarly, in the second embodiment of the vehicle, the swivel coupling 65 is positioned and arranged such that the lowered tower 64 extends forward over the carriage 12, preferably substantially parallel to the conduit 44.

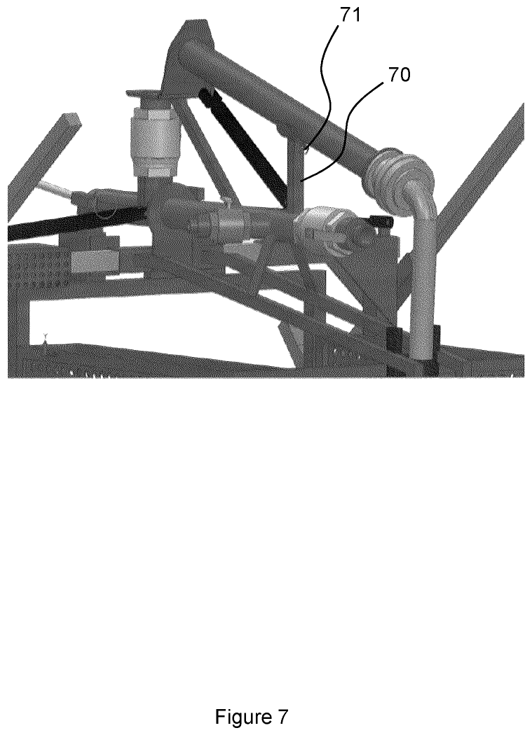

A tower support 70 may extend upward from the conduit 44 and/or the carriage 12 to cradle the tower 64 when it is in the stowed position. FIG. 7 illustrates a locking mechanism 71 on the tower support to secure the tower 64 in a stowed position.

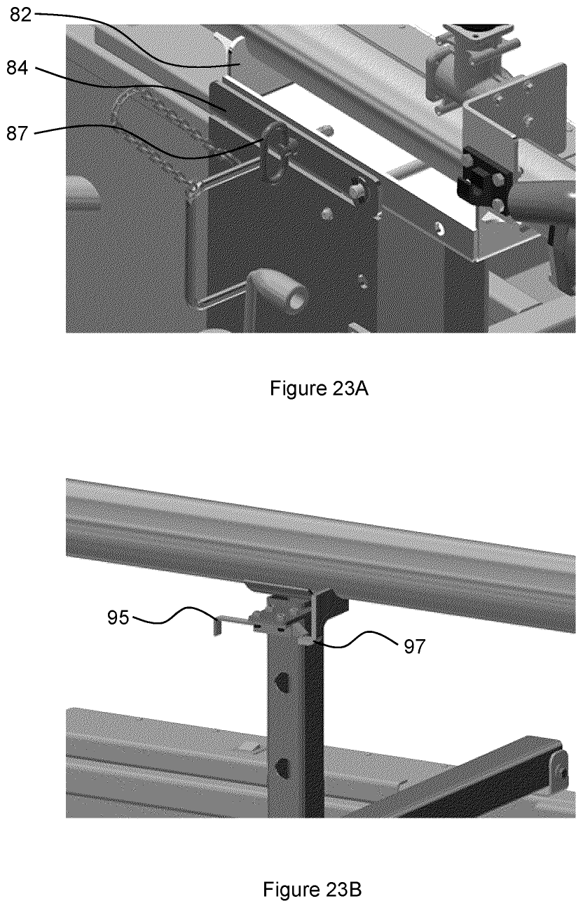

In another embodiment, when the tower 64 is in the stowed position, the bracket 82 nests within the platform 84. As can be seen in FIG. 23A, a further securing mechanism 87, such as a pin, can be used to secure the bracket 82 within the platform 84. Further down the tower 64, additional securing means can be employed. For example, a finger pull latch 95 can be attached to the tower support 70, which engages with a tower catch 97 to further secure the tower 64 in a substantially horizontal stowed position.

Particularly in the third and fourth embodiments as illustrated, in order to facilitate movement of the tower 64 between the stowed and spraying positions, a hydraulic system and/or struts 81 could be employed (See e.g. FIGS. 21A and 21B). Alternatively, or in addition to the hydraulic system and/or struts, the tower 64 is designed so that it is counterweighted. Such mechanical advantages will preferably allow a single user to rotate the tower 64 between both positions. In one embodiment, the counterweighting can substantially be accomplished by balancing the output device 72 at one end of the tower 64 and the one or more connectors 46, 48 at the opposing end of the tower 64. If necessary, further weighting can be added to the tower 64, or portions of the tower 64 can comprise different materials, to offset either the output device 72 or the one or more connectors 46, 48.

An output device 72 is mounted on a second end of the tower 64. The output device 72 can be directly attached to the tower 64, or an intermediate collar 74 may be disposed between the tower 64 and the output device 72. The output device 72 is in fluid communication with the tower 64, and may receive liquid diverted up the tower 64 from the conduit 44. The output device 72 may be interchangeable based on the use of the vehicle 10, and can include e.g. a sprayer, a water cannon, a monitor, a mister, or a fogger. Alternatively, a nozzle 73 of the output device 72 can be adjusted to provide a multitude of spraying patterns and intensities. The output device 72 may be adjustable to control the pressure and volume of liquid that is dispersed. Preferably, the output device is able to deploy liquid at least 100 meters. The output device 72 is preferably rotatably mounted to the second end of the tower 64 to permit rotation thereof, which will expand the dispersion field. The output device 72 may be manually rotated about the tower 64 as necessary, or alternatively, the output device 72 is equipped with a mechanism that rotates or oscillates the output device 72 about the tower during operation.

In one embodiment, the tower 64 is equipped with an output device adjustment mechanism that can manually adjust the trajectory of the output device 72. For example, attached to a lower portion of the tower 64 is a wheel crank 83 that alters the length of a shaft (not shown) relative to the tower 64 via a gearbox. The opposing end of the shaft is connected to the output device 72. As the shaft is extended and retracted via the wheel crank 83, the trajectory of the output device 72 is adjusted.

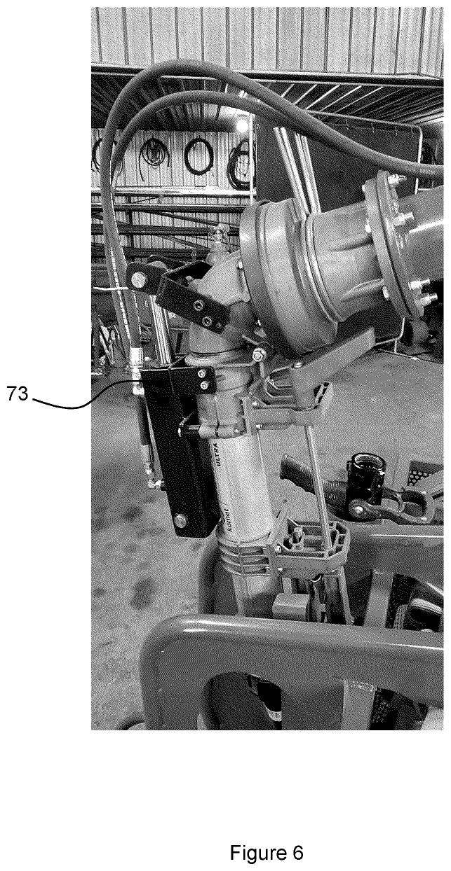

In one embodiment, in order to discourage a full 360° rotation of the output device 72 and/or to direct the output device 72 in a certain general direction, the base of the output device 72, the collar 74, and/or the upper portion of the tower 64 may include stop members (not shown). In this embodiment, the output device 72 may comprise a tab. While rotating about the tower 64, the tab contacts one of the stop members, resulting in the output device 72 stopping its rotation and reversing direction. The position of the stops can be adjusted as needed to dictate the rotational capability of the output device 72. Means 73 to raise and lower the trajectory angle of the output device 72 independent of the tower 64 to alter the launch angle of the liquid from the output device 72, such as through a hydraulic system, may also be included (see FIG. 6).

The vehicle 10 may be equipped with a reservoir (not shown) containing a fire retardant composition, such as a gel-based or foam-based retardant. The reservoir may be in fluid communication with the conduit 44, and when the vehicle 10 is in operation, the fire retardant may be drawn out of the reservoir and mixed with the liquid before being dispersed. Alternatively, the fire retardant composition is manually dispersed directly from the reservoir.

Optionally, the carriage 12 may include additional frame members 80 to reinforce and stabilize the vehicle. For example, at least one frame member 80 may extend from the front of the carriage 12 to the horizontal support 20. This frame member 80 may directly or indirectly provide additional support to the conduit 44.

As can be seen in FIGS. 17-20, any of the embodiments of the vehicle 10 may be outfitted with attachment means 85, such as hooks. Preferably the attachment means are secured to the main structure of the carriage 12. The attachments means allow for the vehicle 10 to be connected to e.g. a helicopter, so that the vehicle can be quickly delivered to remote locations.

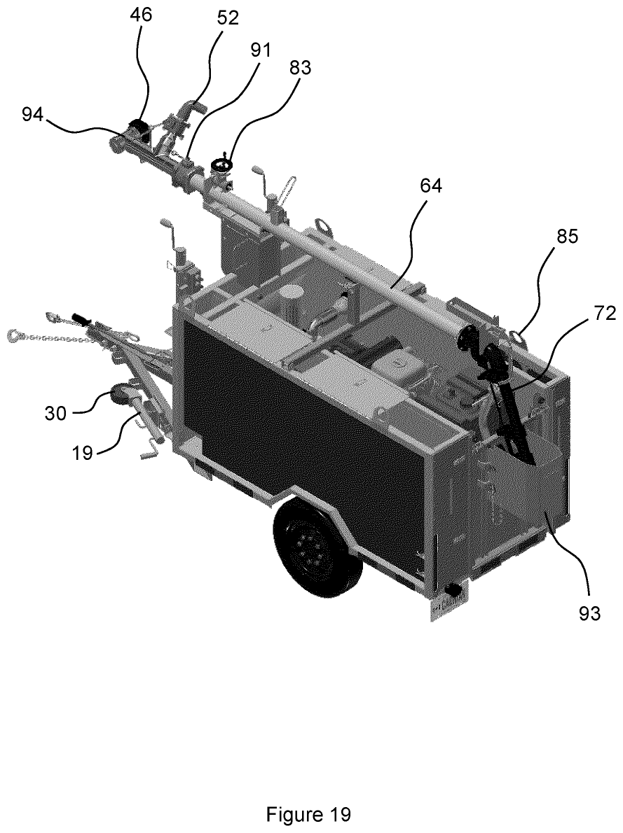

As can be seen in FIG. 19, the vehicle can optionally comprise an encasement 93 that houses at least a portion, such as the nozzle, of the output device 72 when the tower 64 is in the stowed position. In the embodiment shown in FIG. 19, the encasement 93 is releasably attached to the rear of the carriage 12, and can be removed when the rear door 13 is to be deployed.

The carriage 12 can have a torsion axle (not shown). The vehicle 10 may be expected to traverse rough terrain when in use. Incorporating a torsion axle into the carriage 12 will help to absorb shocks thereby creating a smoother ride for the vehicle.

In another embodiment (not shown), certain aspects of the vehicles 10 are motorized including e.g. movement of the vehicle 10, deploying the legs 24 into an extended position, deploying the bracing members 36 into a ground engaging position, outward extension of the supports 76, rotating the posts 19 and/or telescopically extending the posts 19 to engage with the ground, raising and lowering of the tower 64, actuation of the valves 50, 54, 58, the rotational capability of the output device 72, and the adjustment of the angle of trajectory of the output device 72. Preferably, at least some or all of these aspects of the vehicle 10 can be controlled remotely. The vehicle 10 may be equipped with a computer, such as a microprocessor, that is operably connected to control certain features of the vehicle to oversee and implement the remotely issued operating commands. Also, the computer can be connected with communication means that are able to send and/or receive signals from a remotely located control system, thereby allowing a user at a remote location to operate certain aspects of the vehicle. In addition, the vehicle 10 may be equipped with a camera, which will allow the remote operator to control various aspects of the vehicle.

In a system according to an embodiment of the present invention, a number of vehicles as described above are connected in series as shown in FIGS. 17 and 18. A first vehicle 10 is deployed to a desired location, and a liquid source is coupled to the input connector 46. A hose is coupled to the output connector 48 of the first vehicle, and an input connector 46 of a second vehicle that has been deployed in a second location. A plurality of additional vehicles 10 can be connected in series in such a manner. The towers 64 of each vehicle are placed in the spraying position. To deploy the liquid from the system, liquid from the liquid source is allowed to flow to the first vehicle. If present, all input, output, and tower valves are placed in an open position. The liquid can flow from vehicle 10 to vehicle 10 and also up each tower 64 for deployment from the output devices 72. During operation, certain tower valves, if present, can be closed if it is no longer desirable to deploy liquid from certain vehicles 10 in the system. The vehicles 10 can be placed e.g. every 150 meters, to create an extended front for dispersing a liquid. Such a system permits multiple vehicles 10 that can collectively cover a vast area to be supplied by a single liquid source. Actuation of pumps at certain vehicles 10 may be necessary to maintain pressure of the liquid throughout the series.

In addition to the vehicles 10, the system may comprise a large fire truck, such as a tanker or pumper, to supply water to a single vehicle 10 or to the plurality of vehicles 10. A small water pump 79 as shown in FIG. 24 can also be included. An all-terrain vehicle may also be included to tow the vehicles to their desired locations. The system may also comprise a transport trailer that is structured and dimensioned for receiving a plurality of the vehicles 10 and the all-terrain vehicle. The transport trailer is able to relocate these components of the system as needed. The transport trailer may also include a control panel that is able to monitor and/or remotely operate some of all of the remotely controlled functions of the vehicles 10.

The use of the embodiment of the vehicle 10 shown in FIGS. 8 to 11 will now be described, although the first embodiment of the vehicle 10 could be deployed in a similar manner. When in use, the vehicle 10 as described is towed to a desired position via e.g. an ATV or a truck. While the vehicle 10 is still connected, the posts 19 are rotated into a substantially vertical position, and if necessary, the mechanism 21 is operated to telescope the bases 25 down to the ground to stabilize and level the vehicle 10. Confirm that all valves 50, 54, 58 are in the closed position. Operate the raising means 69 to raise the tower 64 into an erect spraying position, and lock the tower 64 in this position.

For the embodiments shown in FIGS. 12 to 24, when the vehicle 10 is in the desired position, the user will need to release any locking mechanisms that are securing the tower 64 to a tower support 70. The tower 64 can then simply be rotated about its connection point until it is in the vertical spraying position. The tower 64 can then be secured in this position with the one or more latching mechanisms.

Once the tower is in the vertical position, a first end of a hose is attached to input connector 46, and the second end of the hose to a liquid source, such as e.g. fire hydrant, tanker, or pump fed by a water source. Rotate and/or raise the output device 72 to the desired position. Turn on the liquid supply, and if present, open the tower valve 58 to provide liquid to the output device 72. If additional vehicles 10 are to be connected, a second vehicle is towed to a second location and set up as described above. Another hose is connected at one end to the output connector 48 of the first vehicle 10 and at the other end to the input connector 46 of the second vehicle 10. The output valve 50 of the first vehicle 10, if present, is opened, which allows the liquid to flow to the second vehicle, which can then be deployed from the second location. In addition, if necessary, a hose can be connected to an auxiliary connector 52, and once the auxiliary valve 54 is opened, an operator can use the hose to deploy the liquid in the immediate vicinity.

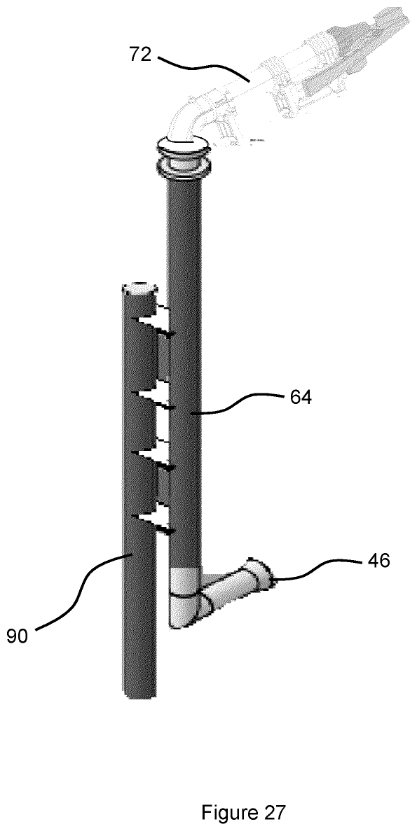

In a further embodiment as shown in FIG. 27, a tower 64 as described above can be affixed directly to a post 90. With this embodiment, a user, such as a homeowner, can have one or more towers 64 in a fixed position, such as in their yard. The user will then only need to connect the input connector 46 of the tower 64 to a water source via e.g. a hose, and the water will be quickly deployed via the output device 72 to protect their home and property from approaching fire. Multiple towers 64 can be erected at different locations around the property, in which case the towers preferably include the T-fitting 94, which will allow the towers 64 to be connected in series.

1-23. (canceled)

24. A mobile liquid deployment vehicle, comprising
a carriage having a plurality of ground engaging wheels;
a longitudinal conduit supported on the carriage, having an input connector at a first end that can receive an inflow of a liquid from a liquid source;
a tower containing a channel therein that is in liquid communication with the conduit, a first end of the tower branching from the conduit;
an output device attached to a second end of the tower that is configured to receive liquid from the tower for deployment; and
a counterweight adapted to facilitate conveyance of the tower between an erect spraying position and a prone stowed position.

25. A mobile liquid deployment vehicle of claim 24, further comprising at least one horizontal support connected to an upper portion of a frame of the carriage, the at least one horizontal support extending substantially transversely to the length of the carriage, and anchoring the conduit to the carriage.

26. The mobile liquid deployment vehicle of claim 24, further comprising means to raise the tower between the erect spraying position and the prone stowed position.

27. The mobile liquid deployment vehicle of claim 24, further comprising a neck portion in liquid communication with the conduit, the neck portion fluidly connecting the conduit and the tower.

28. The mobile liquid deployment vehicle of claim 27, wherein the neck portion and/or the tower comprises a swivel connection that allows the tower to rotate about the neck portion between an erect spraying position and a prone stowed position.

29. The mobile liquid deployment vehicle of claim 27, further comprising an intermediate portion positioned between and fluidly connecting the neck portion and the tower, the intermediate portion comprising a swivel connection that allows the tower to rotate about the neck between an erect spraying position and a prone stowed position.

30. The mobile liquid deployment vehicle of claim 29, wherein the intermediate portion is U-shaped.

31. The mobile liquid deployment vehicle of claim 24, further comprising a tower support attached to the carriage that receives the tower when it is in a stowed position;
an auxiliary connection in fluid communication with the conduit;
at least one post rotatably connected to the carriage, the at least one post having a ground engaging member at one end, and a mechanism to telescopically alter the length of the at least one post;
means to raise and lower the output device to alter a launch angle of the liquid; or an attachment member secured to the carriage, the attachment member adapted to reversibly attach the carriage to a transport vehicle to enable the transport vehicle to lift or tow the mobile liquid deployment vehicle.

32. The mobile liquid deployment vehicle of claim 24, wherein the output device is rotatably attached to the second end of the tower or wherein the output device is a sprayer, a water cannon, a mister, or a fogger.

33. The mobile liquid deployment vehicle of claim 24, wherein a second end of the conduit comprises an output connector.

34. The mobile liquid deployment vehicle of claim 31, wherein the means to raise and lower the output device comprises a shaft adapted to support the output device at one end and for slidable movement along a length of the tower; and
an actuable crank adapted to control direction of the movement of the shaft along the length of the tower to move the output device relative to the tower and to alter a launch angle of the liquid upon actuation of the actuable crank.

35. A mobile liquid deployment vehicle, comprising
a carriage having a plurality of ground engaging wheels;
a tower containing a channel therein that is hingedly connected to the carriage, a first end of the tower having an input connector to receive liquid;
an output device attached to a second end of the tower that is configured to receive liquid from the tower for deployment; and
a counterweight adapted to facilitate conveyance of the tower between an erect spraying position and a prone stowed position.

36. The mobile liquid deployment vehicle of claim 35, further comprising a latching mechanism to secure the tower in an erect spraying position; a bracket hingedly connected to the top of the carriage, the bracket being secured to the tower; at least one post rotatably connected to the carriage, the at least one post having a ground engaging member at one end, and a mechanism to telescopically alter the length of the at least one post; or an attachment member secured to the carriage, the attachment member adapted to reversibly attach the carriage to enable a transport vehicle to lift or tow the mobile liquid deployment vehicle.

37. The mobile liquid deployment vehicle of claim 35, wherein the first end of the tower comprises a T-fitting, the input connector is at a first end of the T-fitting, and an output connector is at the opposing end of the T-fitting.

38. The mobile liquid deployment vehicle of claim 36, wherein the at least one post is secured to a support element, the support element comprising means to extend laterally from the vehicle.

39. A mobile fire suppression or fire retardant deployment vehicle, the vehicle comprising:
a moveable carriage supportable by the ground;
a conduit supported by the carriage for receiving an inflow of a fire suppression or fire retardant from a source;
a pivotally moveable tower comprising a channel that is in fluid communication with the conduit;
an output device that is in fluid communication with the channel, the output device is configured to discharge the fire suppression or fire retardant away from the tower;
a counterweight adapted to facilitate pivotal movement of the tower between an erect spraying position and a prone stowed position; and
means to raise and lower the output device comprising:
a shaft adapted to support the output device at one end and for slidable movement along a length of the tower; and
an actuable crank adapted to control direction of the movement of the shaft along the length of the tower to move the output device relative to the tower and to alter a launch angle of the fire suppression or fire retardant upon actuation of the actuable crank.
